(19) United States
(12) Patent Application Publication
(10) Pub. No.: US 2023/0089766 A1
(43) Pub. Date: Mar. 23, 2023

(54) AUDIO DEVICE, PROGRAM, MUSIC MANAGEMENT METHOD

(71) Applicant: AlphaTheta Corporation, Yokohama-shi, Kanagawa (JP)

(72) Inventors: Takashi Mashita, Yokohama-shi, Kanagawa (JP); Shintaro Kido, Yokohama-shi, Kanagawa (JP); Masayuki Mikasa, Yokohama-shi, Kanagawa (JP); Masamichi Tomii, Yokohama-shi, Kanagawa (JP)

(21) Appl. No.: 17/909,022

(22) PCT Filed: Mar. 3, 2020
(86) PCT No.: PCT/JP2020/008936

§ 371 Date: Sep. 2, 2022

(51) Int. Cl. G06F 3/16; G06F 3/0488; G06F 3/0482; G06T 11/00

(52) U.S. Cl. CPC G06F 3/165; G06F 3/0488; G06F 3/0482; G06T 11/00

(57) ABSTRACT

An audio device being a mobile terminal includes: a display a touch panel that is that is provided on a surface of the display; a display controller that causes a second display area including the information related to the sorting destination to be superimposed and displayed on a first display area provided within a screen and including a list of music of the sorting source; an accepting unit that accepts, via the touch panel, the user operation of selecting music to be registered in the sorting destination from the sorting source and the user operation of selecting the sorting destination, in a state in which the superimposed display is maintained by the display controller; and a music sorting unit that adds the music to the sorting destination on the basis of the user operation.

### TECHNICAL FIELD

The present invention relates to an audio device, a program, and a music management method.

### BACKGROUND ART

It is common that a terminal device, for example, displays a list of music which the terminal device is able to play back. For example, Patent Literature 1 discloses a communication terminal that displays a music list which is for playing back shared content corresponding to meta-information acquired from another communication terminal.

### CITATION LIST

### Patent Literature(s)

Patent Literature 1: JP 2018-157576 A

### SUMMARY OF THE INVENTION

### Problem(s) to be Solved by the Invention

In addition to playback of music to be performed by an ordinary user as described above, there is a case where a disc jockey (DJ) performs DJ performance by operating, for example, a playback control device such as a DJ controller, or a computer. In this case, DJ performs a preliminary work called “preparation work” in advance. The preparation work includes a music management work which includes, for example, acquiring and sorting music data. The music management work to be performed by DJ is different from the music management work to be performed by the ordinary user in aim, for example. In the DJ performance, new music and a new playing method are pursued, and DJ thus manages an enormous number of pieces of music as compared with the number of pieces of music managed by the ordinary user. Further, music lists created for the DJ performance tend to be extremely numerous and are frequently updated as compared with music lists of the ordinary user. The preparation work to be performed by DJ, however, also receives a great number of demands for a preparation work using a mobile terminal such as a smartphone or a tablet terminal instead of a computer, as a method that is easily executable without any restrictions on a place at which the work is to be performed.

Accordingly, an object of the invention is to provide an audio device, a program, and a music management method which make it possible for the audio device being a mobile terminal to achieve a music sorting work that is easy and has high operability.

### Means for Solving the Problem(s)

According to an aspect of the invention, there is provided an audio device including: a display configured to display information related to a sorting source of music and information related to a sorting destination; a touch panel provided on a surface of the display and configured to accept a user operation; a display controller configured to cause a second display area including the information related to the sorting destination to be superimposed and displayed on a first display area provided within a screen and including a list of music of the sorting source; an accepting unit configured to accept, via the touch panel, the user operation of selecting music to be registered in the sorting destination from the sorting source and the user operation of selecting the sorting destination, in a state in which the superimposed display is maintained by the display controller; and a music sorting unit configured to add the music to the sorting destination on the basis of the user operation accepted by the accepting unit, in which the audio device is a mobile terminal.

According to another aspect of the invention, a program configured to cause a computer to operate as the audio device according to the above aspect of the invention is provided.

According to still another aspect of the invention, there is provided a music management method to be executed by an audio device including a display configured to display information related to a sorting source of music and information related to a sorting destination, and a touch panel provided on a surface of the display and configured to accept a user operation, the audio device being a mobile terminal, the music management method including: causing a second display area, in which the sorting destination is selected, to be superimposed and displayed on a first display area including a list of music of the sorting source; accepting, via the touch panel, the user operation of selecting music to be registered in the sorting destination from the sorting source and the user operation of selecting the sorting destination, in a state in which the superimposed display of the first display area and the second display area is maintained; and adding the music to the sorting destination on the basis of the user operation.

### BRIEF DESCRIPTION OF DRAWING(S)

FIG. 1 is a block diagram illustrating a schematic functional configuration of an audio device according to an exemplary embodiment of the invention.

FIG. 2 is a diagram illustrating an example of a display screen according to an exemplary embodiment of the invention.

FIG. 3 is flowchart illustrating a music management method according to an exemplary embodiment of the invention.

FIG. 4 is a diagram illustrating another example of the display screen according to an exemplary embodiment of the invention.

FIG. 5 is a diagram illustrating another example of the display screen according to an exemplary embodiment of the invention.

FIG. 6 is a diagram illustrating another example of the display screen according to an exemplary embodiment of the invention.

### DESCRIPTION OF EMBODIMENT(S)

The following describes preferred exemplary embodiments of the invention in detail with reference to the accompanying drawings. It is to be noted that, in this description and the accompanying drawings, components that have substantially the same functional configuration are indicated by the same reference signs, and thus redundant description thereof is omitted.

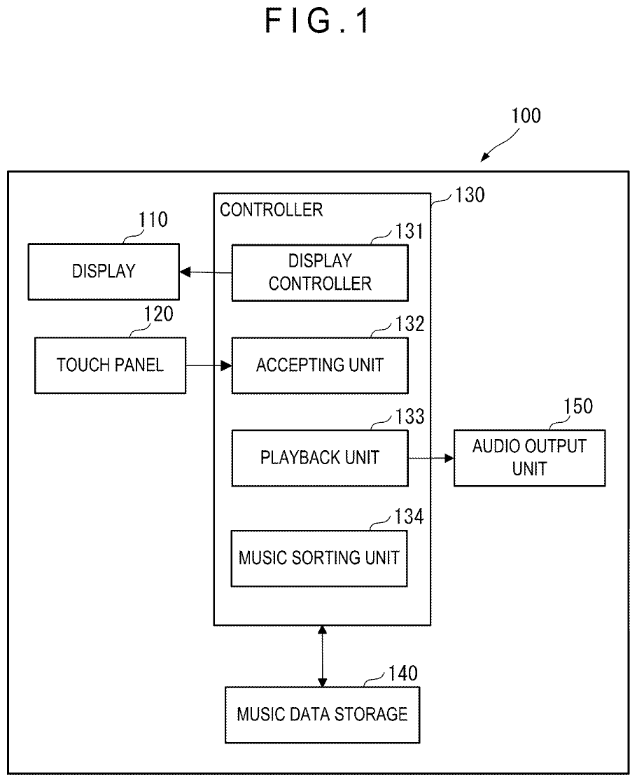

FIG. 1 is a block diagram illustrating a schematic functional configuration of an audio device according to an exemplary embodiment of the invention. The audio device according to an exemplary embodiment of the invention is an audio device being a mobile terminal such as a smartphone or a tablet, Hereinafter, the smartphone will be described as an example of the mobile terminal.

As illustrated in FIG. 1, an audio device 100 includes a display 110, a touch panel 120, a controller 130, a music data storage 140, and an audio output unit 150. Respective functions of the above-described components are achieved by, for example, a processor operating in accordance with a program, in an audio device having a hardware configuration of a computer. Hereinafter, the respective functions of the components will be further described.

The display 110 is a display device that displays a screen including various types of information in the audio device 100 and an operation element for accepting a user operation. As the display 110, a display device of any type is employable such as a liquid crystal display device or an organic EL display device.

The touch panel 120 is provided on a surface of the display 110. The touch panel 120 detects a contact position where a user touches and outputs information of, for example, coordinates indicating the contact position to the controller 130. As the touch panel 120, a touch panel of any type is employable such as an electrostatic capacity type or resistive film type.

The controller 130 is implemented in the audio device 100 by means of, for example, a communication interface, a processor such as a central processing unit (CPU), and a memory to be a work area, and controls operation of the audio device 100. The controller 130 includes a display controller 131, an accepting unit 132, a playback unit 133, and a music sorting unit 134 which are achievable by a processor operating in accordance with a program stored in a memory or received via a communication interface.

The display controller 131 causes the display 110 to display a screen that includes: information of music to be played back by the audio device 100; and a display element (hereinafter, also referred to as “operation element”) of a graphical user interface (GUI) for accepting the user operation related to a music sorting work.

The accepting unit 132 accepts the user operation on the basis of the contact position where the user touches detected by the touch panel 120. Subsequently, the accepting unit 132 supplies information indicating content of the user operation to each component in the controller 130.

The playback unit 133 acquires music data from the music data storage 140, which will be described later, on the basis of the user operation via the touch panel 120 and the accepting unit 132, plays back the music data, and outputs an audio signal to the audio output unit 150, which will be described later.

The music sorting unit 134 registers music in a sorting destination on the basis of the user operation accepted by the accepting unit 132. The sorting destination includes, for example, a playlist and a folder, the playlist including information of multiple pieces of music and order of playback of the multiple pieces of music. The playlist, the folder, etc., may be stored in a storage area included in the controller 130, may be stored in the music data storage 140 to be described later, or may be stored in another storage device including a storage device outside of the audio device 100. Hereinafter, a description is given on the basis that the playlist, the folder, etc., are stored in the music data storage 140, and are created and updated by the music sorting unit 134.

The music data storage 140 is configured to store music data by means of, for example, a hard disk drive (HDD) or a flash memory. The music data storage 140 stores multiple pieces of music data in a predetermined format such as an MP3 format. In addition to audio information, the music data includes, as tag information: information of BPM, an artwork, a title, a name of an artist, a name of an album, a key, the number of times played by DJ, a genre, etc., of the music. The music data to be stored in the music data storage 140 is associated with a time stamp which is information of a playback position.

The audio device 100 may include a communication interface, may acquire music data stored in, for example, an external storage device and a computer, via an unillustrated communication interface, and may play back the music data by the playback unit 133. In this case, the audio device 100 does not include the music data storage 140, and the external storage device operates as the music data storage 140.

The audio output unit 150 includes, for example, a speaker and a headphone terminal, and outputs the audio signal of the music data played back by the playback unit 133 as the audio information.

A description is given of a display screen on the display 110 of the above-described audio device 100 which is to be displayed when the user performs the music sorting work. It is to be noted that the music sorting work is performed during playback of music, and during displaying of a list of music (a library, a collection, etc.). Specifically, for example, the user is able to register music being played back in any playlist or folder while playing back music data by the playback unit 133. Also, for example, the user is able to register music being displayed in any playlist or folder while viewing the list of music on the display 110.

Hereinafter, the sorting work to be performed during playback of music will be described as an example.

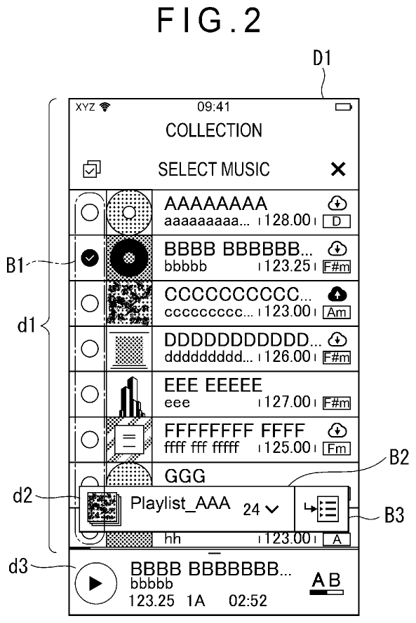

FIG. 2 is a diagram illustrating an example of a display screen according to the present exemplary embodiment. As illustrated in FIG. 2, the display controller 131 displays, on the display 110, information related to a sorting source, information related to the sorting destination, and information indicating music currently being played back.

In FIG. 2, a display screen D1 includes: a first display area d1 that includes a list of music of the sorting source; a second display area d2 that includes the information related to the sorting destination and is superimposed and displayed on the first display area d1; and a third display area d3 that displays the information indicating the music currently being played back.

The first display area d1 displays: the list of music of the sorting source; and a checkbox 31 which is a display element for selecting an item, i.e., music, in the list. The list of music includes, for example, a title, a name of an artist, a thumbnail related to music.

It is possible to select two or more pieces of music in the checkbox B1. In other words, it is possible to simultaneously select, as music to be registered in a playlist which is the sorting destination, multiple pieces of music included in the same list of music of the sorting source. In the sorting work, the registration in the playlist has often been performed for a single item, for example, on a per-music basis or on a per-album basis. However, allowing multiple items desired by the user to be registerable in the playlist in one process makes it possible to improve workability of the user.

Although FIG. 2 illustrates an example in which all pieces of music are displayed as the sorting source, the sorting source may include, for example, pieces of music included in an album or pieces of music included in a playlist. Various known configurations are applicable to switching of the lists to be displayed between the all pieces of music, the pieces of music included in the album, the pieces of music included in the playlist, etc., and therefore detailed descriptions thereof are omitted.

The second display area d2 displays: a selection box B2 which is a display element for selecting a playlist of the sorting destination; and an add music button B3. The selection box B2 displays, as information of a playlist currently being selected, information of a name of the playlist, the number of pieces of music registered in the playlist, etc.

Although FIG. 2 illustrates an example in which the playlist is displayed as the sorting destination, a folder may be selected as the sorting destination. In this case, a selection box which is a display element for selecting the folder of the sorting destination is displayed instead of the selection box B2.

The third display area d3 displays a playback or pause button and basic information of a title, a name of an artist, etc., of music being played back.

The first display area d1 superimposes and displays the second display area d2 thereon, and accepts the user operation of selecting, from the sorting source, music to be registered in the sorting destination while maintaining the superimposed display. The second display area d2 is superimposed and displayed on the first display area d1, and accepts the user operation of selecting the sorting destination while maintaining the superimposed display. The third display area d3 is constantly displayed independently of the first display area d1 and the second display area d2 described above, and may accept the user operation related to music being played back, or may change a mode of the display and an acceptance status of the user operation in conjunction with behavior of the first display area d1 and the second display area d2.

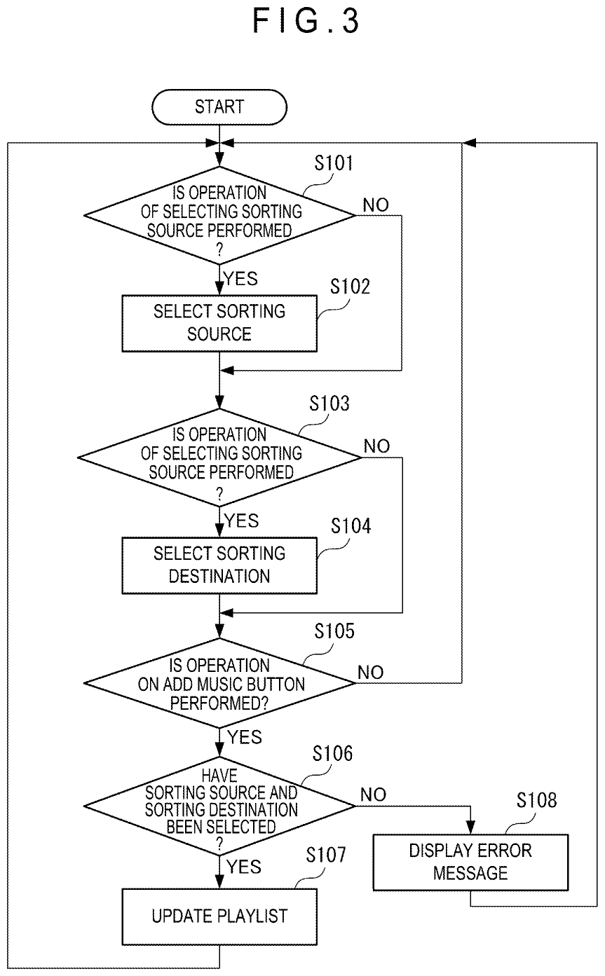

FIG. 3 is flowchart illustrating operation of each component upon sorting music.

In the example illustrated in FIG. 3, first, the accepting unit 132 determines whether an operation of selecting the sorting source is performed via the touch panel 120 (Step S101), The user selects the sorting source by selecting the checkbox B1 of the first display area d1, as described above. Here, the sorting source includes all pieces of music, music included in an album, music included in a playlist, etc. In the selecting operation, it is also possible to change the sorting source from the all pieces of music to the album, or from the album to the playlist, for example.

When the accepting unit 132 determines that the operation of selecting the sorting source is performed (Step S101: YES), the music sorting unit 134 selects a music group of the sorting source on the basis of the selecting operation (Step S102), When the accepting unit 132 does not determine that the operation of selecting the sorting source is performed after a predetermined period of time (Step S101: NO), the process proceeds to Step S103, and the process continues with respect to the music group of the sorting source which has already been selected at that point of time.

It is to be noted that, during and after the operation of selecting the sorting source, the superimposed display of the first display area d1 and the second display area d2 is maintained, and transition between display screens does not occur. This allows the user to perform the operation of selecting the sorting source without interrupting an operation that has originally been performed.

Subsequently, the accepting unit 132 determines whether an operation of selecting the sorting destination is performed via the touch panel 120 (Step S103), The user selects the sorting destination by selecting the selection box B2 of the second display area d2, as described above. Here, the sorting destination includes a playlist or a folder. The selecting operation causes any playlist of the sorting destination to be selected or causes the sorting destination to be changed from the playlist to the folder.

When the accepting unit 132 determines that the operation of selecting the sorting destination is performed (Step S103: YES), the music sorting unit 134 selects a playlist which is the sorting destination on the basis of the selecting operation (Step S104). When the accepting unit 132 does not determine that the operation of selecting the sorting destination is performed after a predetermined period of time (Step S103: NO), the process proceeds to Step S105, and the process continues with respect to the sorting destination which has already been selected at that point of time,

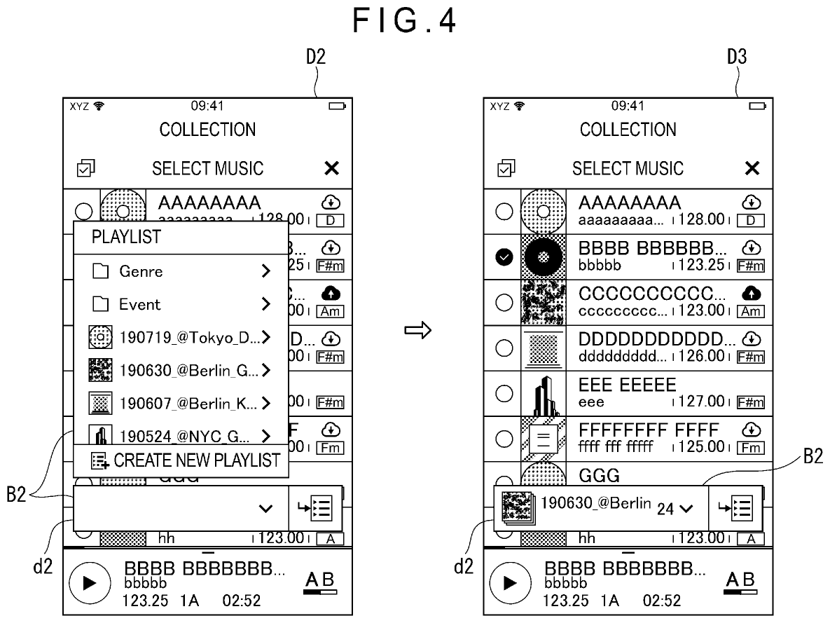

When the sorting destination is selected by the user operation of selecting the selection box B2, the display 110 displays a display screen D2 illustrated in FIG. 4. The selection box B2 of the display screen D2 includes a list of playlists (including new playlist creation) which is superimposed and displayed on the first display area d1. When the user operation of selecting any playlist is performed, the display 110 displays a display screen D3 illustrated in FIG. 4. In the second display area d2 of the display screen D3, information indicating the selected playlist is displayed in the selection box B2. When the user operation of newly creating a playlist is performed, the music sorting unit 134 creates a new playlist. It is to be noted that portions other than the second display area d2 of the display screens D2 and D3 are similar to those of the display screen D1. In FIGS. 4 to 6, only portions that are different from those of the display screen D1 will be described, and descriptions of portions that are similar to those of the display screen D1 will be omitted.

It is to be noted that, during and after the operation of selecting the sorting destination, the superimposed display of the first display area d1 and the second display area d2 is maintained, and the transition between display screens does not occur. This allows the user to perform the operation of selecting the sorting destination without interrupting the operation that has originally been performed.

Subsequently, the accepting unit 132 determines whether an operation on an add music button is performed via the touch panel 120 (Step S105). The user selects the add music button B3 in the second display area d2 to thereby add music of the sorting source to the sorting destination, as described above.

When the accepting unit 132 determines that the operation on the add music button is performed (Step S105: YES), the music sorting unit 134 determines whether the sorting source and the sorting destination have been selected (Step S106). When the accepting unit 132 does not determine that the operation on the add music button is performed after a predetermined period of time (Step S105: NO), the process returns to Step S101, and the process continues with respect to the sorting source and the sorting destination that have already been selected at that point of time,

When the music sorting unit 134 determines that the sorting source and the sorting destination have been selected (Step S106: YES), the music sorting unit 134 updates the playlist (Step S107).

For updating the playlist, the music sorting unit 134 adds the music that has been selected as the sorting source to the playlist that has been selected as the sorting destination out of the playlists stored in the music data storage 140, thereby updating the playlist. Further, upon updating the playlist, the display controller 131 reflects a playlist-updated result on the display 110.

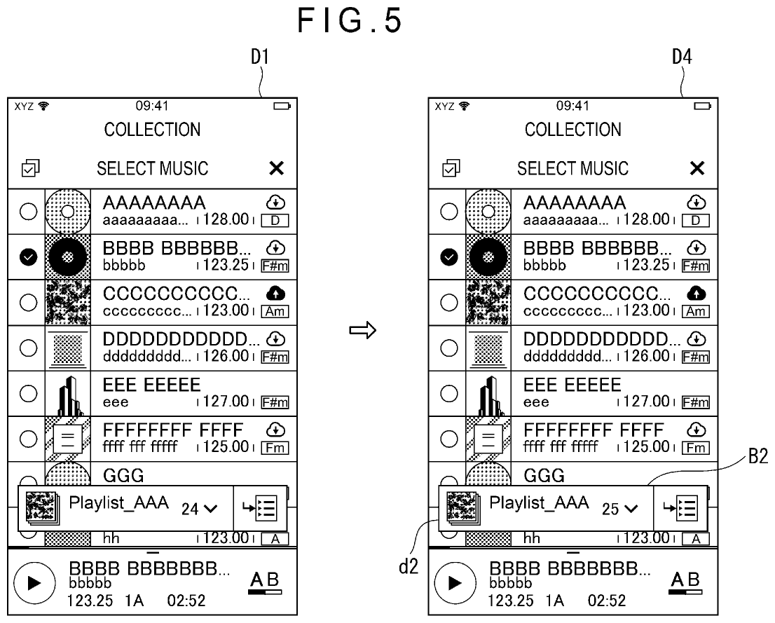

When the playlist is updated, a display screen D4 illustrated in FIG. 5 is displayed on the display 110. In the second display area d2 of the display screen D4, the information of the playlist currently being selected is displayed in the selection box B2, and when the playlist is updated, the change in the number of pieces of music included in the playlist is reflected. For example, in the display screen D1 before the playlist update, the number of pieces of music is 24, but in the display screen D4 after the playlist update of adding one piece of music, the number of pieces of music is 25.

It is to be noted that, during and after the playlist update, the superimposed display of the first display area d1 and the second display area d2 is maintained, and the transition between display screens does not occur. This allows the user to update the playlist without interrupting the operation that has originally been performed.

When the music sorting unit 134 determines that the sorting source and the sorting destination have not been selected, in other words, the sorting source, the sorting destination, or both have been unselected (Step S106: NO), the display controller 131 displays an error message on the display 110 (Step S108). For example, the display controller 131 notifies the user of the error by causing the display 110 to display text information of, for example, “no music (which is the sorting source) is selected” and “no playlist (which is the sorting destination) is selected”.

The sorting work is executed by the series of operations described so far. It is to be noted that the sorting work is also executed in a similar manner in a case where the user is not playing back music, for example, in a case where the user displays and browses the list of music on the display 110.

Further, it is possible to confirm and edit registered content of the playlist in response to a predetermined user operation. For example, in a case where the user selects a part of the selection box B2 of the second display area d2 in which the name of the playlist currently being selected is displayed, a screen for confirming and editing the registered content of the playlist may be displayed.

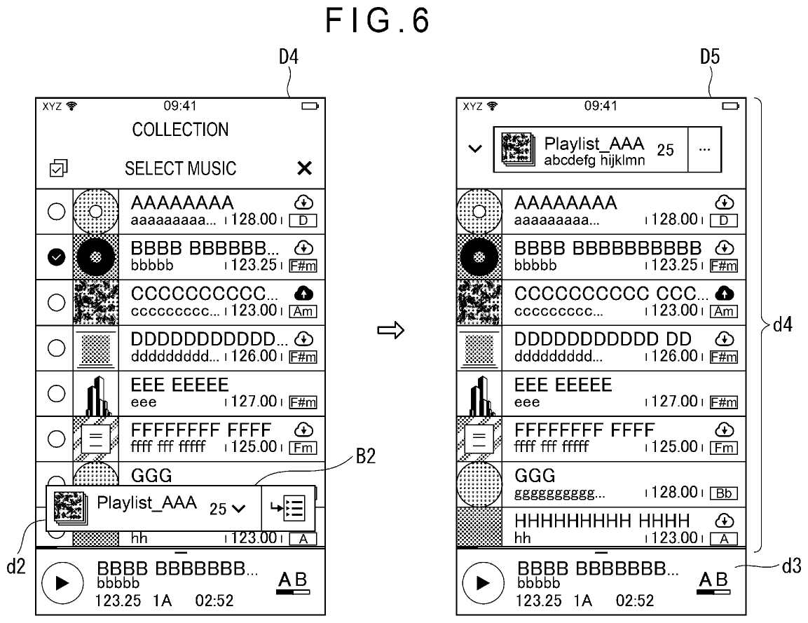

For example, in a case where an instruction for confirming and editing the registered content of the playlist is issued by the user operation, a display screen D5 illustrated in FIG. 6 may be displayed on the display 110. The display screen D5 includes: a fourth display area d4 including a list of pieces of music included in the playlist, as the registered content of the playlist; and the third display area d3 described above. It is to be noted that the fourth display area d4 may include, for example, an operation element for accepting the user operation for editing the registered content of the playlist. Various known configurations are applicable to the confirming and editing of the registered content of the playlist, and therefore detailed descriptions thereof are omitted.

According to an exemplary embodiment of the invention as described above, it is possible for the audio device being a mobile terminal to achieve high operability and visibility in performing a preparation work.

In music management performed by an ordinary user, two methods are used in a case of creating a playlist, A first method is performed in the following procedure.

(1) Selecting or newly creating a playlist which is the sorting destination.

(2) Selecting music which is the sorting source.

(3) Executing sorting.

A second method is performed in the following procedure.

(A) Selecting music which is the sorting source.

(B) Selecting or newly creating a playlist which is the sorting destination.

(C) Executing sorting.

In both methods, the selecting of the sorting source and the selecting of the sorting destination are performed using respective separate display screens. This causes the transition of the screens in the display to occur frequently. In both methods, the number of steps of selections and decisions to be performed by the user is also large, which results in a troublesome work for the user,

In contrast, according to an exemplary embodiment of the invention, the second display area including the information related to the sorting destination is caused to be superimposed and displayed on the first display area including the information related to the sorting source of music, and the user operation of selecting the music to be registered in the sorting destination from the sorting source and the user operation of selecting the sorting destination are accepted, in a state in which the superimposed display is maintained. Accordingly, the user is able to perform operation with respect to the sorting source and the operation with respect to the sorting destination without causing the transition between the display screens. This makes it possible to perform the sorting work in the preparation work by intuitive and easy operation.

Further, according to an exemplary embodiment of the invention, in a state in which the sorting destination of the playlist is selected, it is possible to perform the registration in the playlist in two steps, i.e., the operation of selecting the sorting source and the adding operation. Accordingly, even a mobile terminal which uses a touch panel for operation is able to easily and efficiently perform the sorting work with a sense of operation close to drag-and-drop performed in a user interface using a pointing device such as a mouse, for example.

Further, according to an exemplary embodiment of the invention, the second display area including the information related to the sorting destination is caused to be superimposed and displayed on the first display area including the information related to the sorting source. Accordingly, even the audio device 100 being a mobile terminal is able to achieve high operability and high visibility without reducing an amount of information to be displayed on the display screen or reducing a size of an object such as the operation element.

It is to be noted that each of the display screens described in the above exemplary embodiment is an example, and elements, designs, arrangement, and the like are not limited to those in the present exemplary embodiment. For example, in addition to the list of music in the first display area d1, or in place of the list of music, waveform information and partial waveform information of entire music may be displayed. Further, the elements, the designs, the arrangement, and the like of each display screen may be set by the user. However, the operation elements such as the checkbox and the selection box to be selected by the user or the display screen, in particular, the second display area d2 in which the selection box B2 from which the playlist of the sorting destination is selectable, is preferably displayed, within the display screen on the display 110, at a position selectable by a thumb of a hand with which the user holds the audio device 100 in a state of holding the audio device 100 with one hand.

Further, in the above exemplary embodiment, the description is given of the audio device 100 including one display 110 as an example; however, the invention may be applied to the audio device 100 including two or more display devices.

In the above exemplary embodiment, the description is given of the audio device being a smartphone as an example of the audio device 100; however, the audio device 100 may be an audio device being a mobile terminal such as a tablet terminal. Further, the invention may be applied to, for example, a player, a mixer that controls a player, a DJ system in which a player and a mixer are integrated, a DJ controller that does not have a playback function, an electronic musical instrument, a karaoke device, and a game console.

Further, in the above exemplary embodiment, the controller 130 of the audio device 100 performs the above-described process by reading and executing a program from an unillustrated storage and an unillustrated recording medium. However, the invention is not limited thereto, and for example, the controller 130 may acquire and execute a program from a device on a network. Examples of the recording medium include a disk-type recording medium, an HDD, and a semiconductor memory.

Preferred exemplary embodiments of the invention have been described above in detail with reference to the accompanying drawings, but the invention is not limited to such exemplary embodiments. It is apparent that a person having ordinary skill in the art to which the invention pertains can arrive at various alterations and modifications within the scope of the technical idea recited in the appended claims, and it is understood that such alterations and modifications naturally fall within the technical scope of the invention.

### EXPLANATION OF CODES

100 . . . audio device, 110 . . . display, 120 . . . touch panel, 130 . . . controller, 131 . . . display controller, 132 . . . accepting unit, 133 . . . playback unit, 134 . . . music sorting unit, 140 . . . music data storage, 150 . . . audio output unit

1. An audio device, comprising:
a display configured to display information related to a sorting source of music and information related to a sorting destination;
a touch panel provided on a surface of the display and configured to accept a user operation;
a display controller configured to cause a second display area including the information related to the sorting destination to be superimposed and displayed on a first display area provided within a screen and including a list of music of the sorting source;
an accepting unit configured to accept, via the touch panel, the user operation of selecting music to be registered in the sorting destination from the sorting source and the user operation of selecting the sorting destination, in a state in which the superimposed display is maintained by the display controller; and
a music sorting unit configured to add the music to the sorting destination on a basis of the user operation accepted by the accepting unit, wherein
the audio device is a mobile terminal.

2. The audio device according to claim 1, wherein the sorting destination includes at least one of a playlist or a folder, the playlist including information of multiple pieces of music and order of playback of the pieces of music.

3. The audio device according to claim 1, wherein the sorting source includes at least one of a list of music, a list of an album, or a playlist including information of multiple pieces of music and order of playback of the pieces of music.

4. The audio device according to claim 3, wherein the accepting unit accepts the user operation of simultaneously selecting multiple items included in the same list of the sorting source, as items to be registered in the sorting destination, in a state in which the superimposed display is maintained by the display controller.

5. The audio device according to claim 1, wherein
the accepting unit accepts the user operation of confirming registered content of the sorting destination via the touch panel, in the state in which the superimposed display is maintained by the display controller, and
the display controller causes the display to display information indicating the registered content.

6. The audio device according to claim 5, wherein
the accepting unit accepts the user operation of editing the registered content of the sorting destination via the touch panel, and
the display controller causes the display to display information related to the editing performed on the registered content.

7. The audio device according to claim 1, wherein at least a portion of the second display area is displayed, within a display screen on the display, at a position selectable by a thumb of a hand with which a user holds the mobile terminal in a state of holding the mobile terminal with one hand.

8. A non-transitory computer-readable recording medium storing therein a program configured to cause a computer to operate as the audio device according to claim 1.

9. A music management method to be executed by an audio device comprising a display configured to display information related to a sorting source of music and information related to a sorting destination, and a touch panel provided on a surface of the display and configured to accept a user operation, the audio device being a mobile terminal, the music management method comprising:
causing a second display area, in which the sorting destination is selected, to be superimposed and displayed on a first display area provided within a screen and including a list of music of the sorting source;
accepting, via the touch panel, the user operation of selecting music to be registered in the sorting destination from the sorting source and the user operation of selecting the sorting destination, in a state in which the superimposed display of the first display area and the second display area is maintained; and
adding the music to the sorting destination on a basis of the user operation.
